(19) United States
(12) Patent Application Publication
(10) Pub. No.: US 2006/0232540 A1
(43) Pub. Date: Oct. 19, 2006

(54) DISPLAY

(75) Inventor: Akitoshi MIYAOKA, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 11/276,777

(22) Filed: Mar. 14, 2006

(30) Foreign Application Priority Data
Apr. 13, 2005 (JP) 2005-115539

(51) Int. Cl. G09G 3/36

(52) U.S. Cl. 345/98

(57) ABSTRACT

A display has active elements and pixels arrayed in a matrix and drives the active elements to apply a voltage to the pixels for displaying an image. The display includes a gate driver IC for generating a signal for controlling the active elements, a plurality of gate interconnect lines for supplying the signal to the active elements, a source driver IC for generating a voltage to be applied to the pixels, a plurality of source interconnect lines for supplying the voltage to the pixels, and a switching circuit provided between the source driver IC and the plurality of source interconnect lines and having individually-switchable groups for supplying the voltage generated by the source driver IC to all of the source interconnect lines.

### BACKGROUND OF THE INVENTION

1. Field of the Invention

The present invention relates to a display, and more particularly to a display having active elements and pixels arrayed in a matrix.

2. Description of the Background Art

In recent years, liquid crystal displays featuring flatness and low-power consumption have been receiving attention. Such liquid crystal displays are generally divided into passive and active types. For the purpose of upsizing and finer resolution, active-type liquid crystal displays are superior. An active-type liquid crystal display (hereinafter simply referred to as a liquid crystal display) has active elements and pixels arrayed in a matrix, and controls the respective active elements to apply a predetermined voltage to the pixels for controlling the orientation of liquid crystal. General liquid crystal displays in many cases employ thin film transistors (TFTs) as active elements.

A liquid crystal display further includes gate interconnect lines and source interconnect lines for supplying signals or the like to the active elements and pixels, respectively, to drive the active elements and to apply a predetermined voltage to the pixels. Each gate interconnect line and each source interconnect line are provided with a gate terminal and a source terminal, respectively, to be connected to driver ICs. A driver IC is a circuit for generating and supplying signals and the like for driving the active elements.

Referring to a liquid crystal display of XGA (Extended Graphics Array) by way of example, this liquid crystal display requires 768 gate interconnect lines and 1024×3 (in the case of RGB color display)=3072 source interconnect lines. The number of outputs of driver ICs is generally 384. Accordingly, two and eight driver ICs are required on the gate interconnect lines side and on the source interconnect lines side, respectively.

Finer the resolution of such liquid crystal display, the greater the number of driver ICs required. Japanese Patent Application Laid-Open No. 2004-354567 exemplary shows such liquid crystal display having a plurality of driver ICs connected thereto.

As the number of driver ICs for use in a liquid crystal display increases, however, manufacturing costs increase in turn. More specifically, the increase in manufacturing costs is caused by a relatively high unit cost of driver ICs and an increased number of steps of connecting the driver ICs to terminals. Further, the increased number of driver ICs for use in a liquid crystal display also results in increased consumption power. The increased number of driver ICs means an increase in the number of components of the liquid crystal display. Accordingly, the liquid crystal display panel will suffer degradation in reliability unless driver ICs having lower failure rate are used.

Further, outputs of individual products may vary even when driver ICs of identical specifications are used. Accordingly, increasing the number of driver ICs adversely causes faulty display (nonuniformity in stripes, etc.) resulting from variations in outputs of driver ICs.

### SUMMARY OF THE INVENTION

An object of the present invention is to provide a liquid crystal display with less driver ICs used.

According to the present invention, the display has active elements and pixels arrayed in a matrix and driving the active elements to apply a voltage to the pixels for displaying an image. The display includes a gate driver circuit for generating a signal for controlling the active elements, a plurality of gate interconnect lines for supplying the signal to the active elements, a source driver circuit for generating a voltage to be applied to the pixels, a plurality of source interconnect lines for supplying the voltage to the pixels, and a first switching circuit provided between the source driver circuit and the plurality of source interconnect lines, the first switching circuit having individually-switchable groups for supplying the voltage generated by the source driver circuit to all of the plurality of source interconnect lines.

The display includes the first switching circuit having individually-switchable groups for supplying the voltage generated by the source driver circuit to all of the source interconnect lines. Accordingly, the number of source driver circuits to be used is reduced, which, in turn, achieves cost reduction and improved reliability of the display.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram showing a liquid crystal display according to a first preferred embodiment of the present invention;

FIG. 2 is a circuit diagram showing a liquid crystal display according to a second preferred embodiment of the invention;

FIG. 3 is a circuit diagram showing a liquid crystal display according to a third preferred embodiment of the present invention; and

FIG. 4 is a circuit diagram showing a liquid crystal display according to a fourth preferred embodiment of the present invention.

### DESCRIPTION OF THE PREFERRED EMBODIMENTS

### First Preferred Embodiment

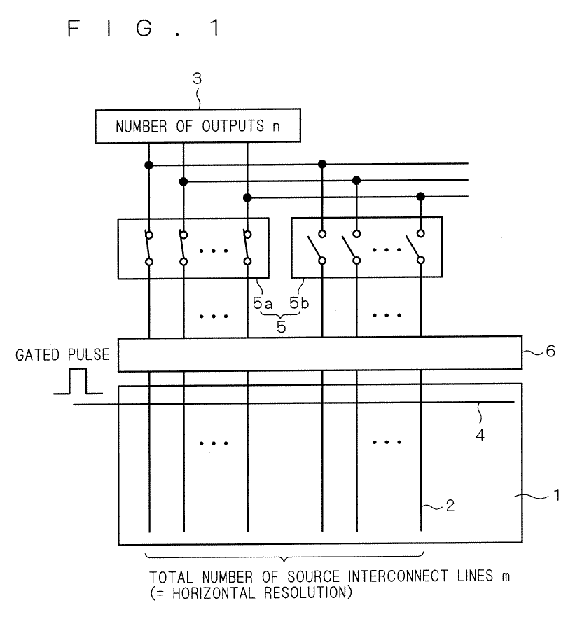

FIG. 1 is a circuit diagram showing a liquid crystal display according to a first preferred embodiment of the present invention. In FIG. 1, a source driver IC 3 is connected to source interconnect lines 2 provided on a liquid crystal panel 1. It should be noted that FIG. 1 does not show active elements or pixels in the liquid crystal panel 1; nor it shows gate driver ICs, whereas only one gate interconnect line 4 is illustrated.

Active elements and pixels, not shown, are arrayed in a matrix in the liquid crystal panel 1. Upon receipt of gated pulses supplied from gate driver ICs through gate interconnect lines 4, the respective active elements are driven. When the active elements are driven, source signals of source driver ICs 3 are written into pixels through the source interconnect lines 2. By writing source signals into pixels, a predetermined voltage is applied to the pixels, so that a desired image is displayed.

Further, in the liquid crystal display according to the present embodiment, the source interconnect lines 2 and source driver IC 3 are not directly connected to each other, but a switching circuit 5 and a memory circuit 6 for display are provided therebetween. The memory circuit 6 is configured to store source signals for the respective source interconnect lines 2, and the switching circuit 5 is also configured to be turned on and off for each of the source interconnect lines 2. Here, a source signal is a signal indicative of a voltage applied to a pixel.

The switching circuit 5 is turned on and off by the number of outputs of the source driver IC 3. The switching is made in a unit called a switching group. FIG. 1 shows that the switching circuit 5 is packaged by each switching group, however, the present invention is not limited as such, but may be implemented by packaging each several switching groups or packaging the whole switching groups all together.

Providing the switching circuit 5 in the liquid crystal display according to the present embodiment, one source driver IC 3 can supply source signals to the source interconnect lines 2 connected to a plurality of switching groups. With reference to FIG. 1, by way of example, the source driver IC 3 is connected to the switching circuit 5 formed by a plurality of switching groups including a switching group 5a and a switching group 5b. With the switching group 5a remaining on and the switching group 5b remaining off as shown, the source driver IC 3 supplies source signals for the switching group 5a to the memory circuit 6.

Next, the number s of switching groups required in the case where one source driver IC 3 supplies source signals to all the source interconnect lines 2 is calculated. Let the total number of source interconnect lines (=horizontal resolution) be m, and the number of outputs of one source driver IC 3 be n. Then, the number s of switching groups required is obtained by dividing the total number of source interconnect lines m by the number of outputs n. More specifically, in a liquid crystal display of XGA, let the total number of source interconnect lines m be 3072 and the number of outputs n of the source driver IC 3 be 384, the number s of switching groups shall be 8.

The present invention does not always require one source driver IC 3 to supply source signals to all the source interconnect lines 2, but a plurality of source driver ICs 3 may be provided. It should be noted that the number t of source driver ICs 3 needs to be equal to or less than the number s of switching groups. Accordingly, the number of source driver ICs 3 is less than in a conventional liquid crystal display. When providing a plurality of source driver ICs 3, sit switching groups are connected to one source driver IC 3.

Next, an operation of the liquid crystal display according to the present embodiment is described with reference to FIG. 1. First, although not shown, n pieces of data are input to the source driver IC 3 (the number of outputs n) from a controller. The source driver IC 3 generates n source signals on the basis of the input data, and supplies the signals to the switching circuit 5. The switching circuit 5 has s switching groups, each of which is individually turned on and off. The control of switching may be directly conducted by an application specific integrated circuit (ASIC) provided separately and connected to each of the switching groups (switching circuit 5). However, the present invention is not limited as such, but may be implemented by another configuration, only provided that switching can be made by each switching group with predetermined timing.

As mentioned above, with the switching group 5a remaining on and the switching group 5b remaining off as shown in FIG. 1, outputs of the source driver IC 3 are stored in the memory circuit 6 as source signals for the source interconnect lines 2 corresponding to the switching groups 5a. In other words, source signals are written into a region connected to the switching group 5a in a memory area of the memory circuit 6.

Subsequently, next n pieces of data are input to the source driver IC 3 from the controller. The source driver IC 3 generates next n source signals on the basis of the input data, and supplies the signals to the switching circuit 5. The switching circuit 5, in synchronization with the outputs of the source driver IC 3, turns on the switching group 5b and turns off the switching group 5a. Accordingly, next n source signals are additionally written into the memory circuit 6 as source signals for source interconnect lines 2 corresponding to the switching group 5b.

By conducting the above operation until reaching the s-th switching group, source signals for one line can be stored in the memory circuit 6. Upon receipt of source signals for one line, the memory circuit 6 outputs the source signals to the source interconnect lines 2 at one time. Concurrently with this output, the gate interconnect line 4 receives a gated pulse from a gate driver IC not shown. Here, a gated pulse is a signal for controlling active elements. This gated pulse brings active elements (not shown) connected to the gate interconnect line 4 into the ON state, so that source signals are written into pixels (not shown), and a predetermined voltage is applied to liquid crystal.

Gated pulses are sequentially input to all of gate interconnect lines 4 while repeating the aforementioned operation on the source interconnect lines 2, so that a desired image can be displayed on the liquid crystal display.

As described, the liquid crystal display according to the present embodiment includes the switching circuit 5 having individually-switchable switching groups for supplying source signals (voltage) supplied from the source driver IC 3 to all the source interconnect lines 2 and the memory circuit 6 for temporarily storing outputs of the switching circuit 5 and supplying the outputs to all of the source interconnect lines 2 almost at the same time. Accordingly, the number of source driver ICs 3 to be used is reduced. This, in turn, achieves cost reduction and improved reliability of the liquid crystal display. Further, the liquid crystal display of the present embodiment with less source driver ICs 3 used consumes less power and prevents faulty display (nonuniformity in stripes, etc.) resulting from variations in outputs of driver ICs.

In the example shown in FIG. 1, the switching circuit 5 includes the switching groups and the memory circuit 6 is provided for all the switching groups, however, the present invention is not limited as such. For instance, the memory circuit 6 may be provided for each of the switching groups like the switching circuit 5. Further, the memory circuit 6 and switching circuit 5 may be packaged integrally. Although the present embodiment has been directed to the liquid crystal display, the present invention is not limited as such, but may be applied to a display with pixels arrayed in a matrix including source interconnect lines and gate interconnect lines, e.g., an organic electro-luminescence display.

### Second Preferred Embodiment

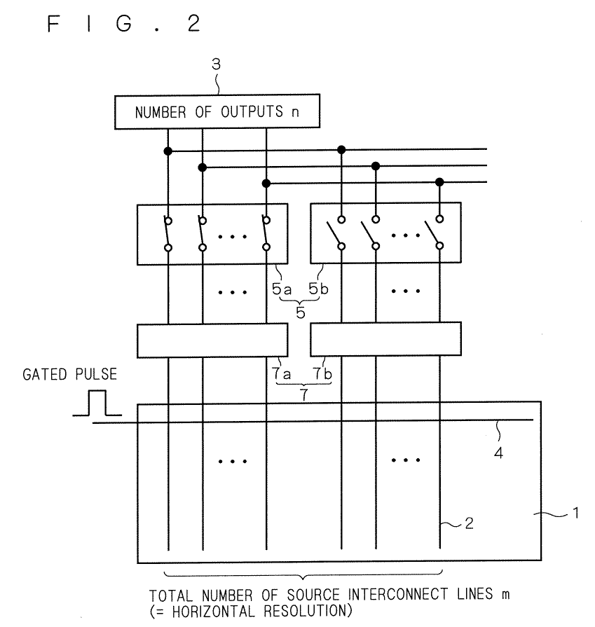

FIG. 2 is a circuit diagram showing a liquid crystal display according to a second preferred embodiment of the present invention. The liquid crystal display shown in FIG. 2 is essentially identical to that shown in FIG. 1 except that a buffer 7 is provided instead of the memory circuit 6. In the liquid crystal display shown in FIG. 2, elements of the same configuration as those in the liquid crystal display shown in FIG. 1 are indicated by the same reference numerals, and redundant explanation is thus omitted here.

The buffer 7 is connected in series to the source interconnect lines 2 and switching circuit 5, and holds source signals to be supplied to the respective source interconnect lines 2 from the source driver IC 3 for a predetermined period of time by each of the source interconnect lines 2. FIG. 2 shows the buffer 7 provided for each of the switching groups. More specifically, a buffer 7a corresponds to the switching group 5a, and a buffer 7b corresponds to the switching group 5b. As described above, however, the buffer 7 only needs to hold source signals for a predetermined period of time, and is not limited in terms of physical packaging. For instance, the buffer 7 may be packaged in one for all of the switching groups.

Next, an operation of the liquid crystal display according to the present embodiment is described with reference to FIG. 2. First, although not shown, n pieces of data are input to the source driver IC 3 (the number of outputs n) from a controller. The source driver IC 3 generates n source signals on the basis of the input data, and supplies the signals to the switching circuit 5. The switching circuit 5 has s switching groups, each of which is individually turned on and off.

With the switching group 5a remaining on and the switching group 5b remaining off as shown in FIG. 2, outputs of the source driver IC 3 are supplied to the buffer 7a as source signals for the source interconnect lines 2 corresponding to the switching group 5a. The buffer 7a holds the potential of the source signals until next source signals are supplied. That is, the source interconnect lines 2 connected to the buffer 7a are at the potential held by the buffer 7a.

Subsequently, next n pieces of data are input to the source driver IC 3 from a controller. The source driver IC 3 generates next n source signals on the basis of the input data, and supplies the signals to the switching circuit 5. The switching circuit 5, in synchronization with the outputs of the source driver IC 3, turns on the switching group 5b and turns off the switching group 5a. Accordingly, next n source signals are supplied to the buffer 7b as source signals for the source interconnect lines 2 corresponding to the switching group 5b. The buffer 7b holds the potential of the source signals until next source signals are supplied.

The above operation is conducted until the s-th switching group, so that the potential of source signals for one line is held by the buffer 7. The buffer 7 does not output source signals to the source interconnect lines 2 at one time upon receipt of source signals for one line like the memory circuit 6 does, but holds the potential of source signals until source signals for one line are received, while sequentially supplying source signals to the source interconnect lines 2.

Accordingly, at the time when the potential of source signals for one line is held (when source signals are supplied from the s-th switching group to a buffer 7s (not shown), and become ready to be supplied from the buffer 7s to source interconnect lines 2), a gated pulse is input from a gate driver IC (not shown) to the gate interconnect line 4. This gated pulse brings active elements (not shown) connected to the gate interconnect line 4 into the ON state, so that source signals are written into pixels (not shown), and a predetermined voltage is applied to liquid crystal.

Gated pulses are sequentially input to all of gate interconnect lines 4 while repeating the aforementioned operation on the source interconnect lines 2, so that a desired image can be displayed on the liquid crystal display.

As described, according to the liquid crystal display according to the present embodiment, similarly to the first preferred embodiment, the number of source driver ICs 3 to be used is reduced. Further, providing the buffer 7 which is less expensive and more reliable than the memory circuit 6 achieves cost reduction and improved reliability of the liquid crystal display.

### Third Preferred Embodiment

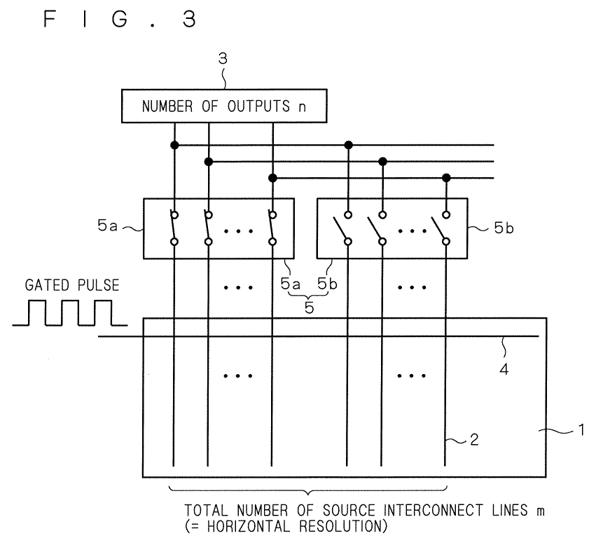

FIG. 3 is a circuit diagram showing a liquid crystal display according to a third preferred embodiment of the present invention. The liquid crystal display shown in FIG. 3 is essentially identical to that shown in FIG. 1 except that the switching circuit 5 and source interconnect lines 2 are directly connected without providing the memory circuit 6. In the liquid crystal display shown in FIG. 3, elements of the same configuration as those in the liquid crystal display shown in FIG. 1 are indicated by the same reference numerals, and redundant explanation is thus omitted here.

Now, an operation of the liquid crystal display according to the present embodiment is described with reference to FIG. 3. First, although not shown, n pieces of data are input to the source driver IC 3 (the number of outputs n) from a controller. The source driver IC 3 generates n source signals on the basis of the input data, and supplies the signals to the switching circuit 5. The switching circuit 5 has s switching groups, each of which is individually turned on and off.

With the switching group 5a remaining on and the switching group 5b remaining off as shown in FIG. 3, outputs of the source driver IC 3 are supplied as source signals for the source interconnect lines 2 connected to the switching group 5a. At this point of time, a gated pulse is input to the gate interconnect line 4 from a gate driver IC (not shown). This gated pulse brings active elements (not shown) connected to the gate interconnect line 4 and corresponding to the switching group 5a into the ON state, so that source signals are written into pixels (not shown), and a predetermined voltage is applied to liquid crystal.

Subsequently, next n pieces of data are input to the source driver IC 3 from the controller. The source driver IC 3 generates next n source signals on the basis of the input data, and supplies the signals to the switching circuit 5. The switching circuit 5, in synchronization with the outputs of the source driver IC 3, turns on the switching group 5b and turns off the switching group 5a. Accordingly, next n source signals are supplied as source signals for the source interconnect lines 2 connected to the switching group 5b. At this point of time, a gated pulse is input to the gate interconnect line 4 from a gate driver IC (not shown).

By conducting the above operation until reaching the s-th switching group, source signals for one line can be written into pixels. However, the source interconnect lines 2 connected to the respective switching groups are unstable in potential until next source signals are supplied. In other words, the source interconnect lines 2 are in a floating state except while a corresponding switching group remains on. Further, according to the present embodiment, (s−1) gated pulses are input to a single gate interconnect line 4 until next source signals are supplied. Accordingly, considering influences exerted upon a displayed image and the like, it is preferable to reduce the number of switching groups connected to one source driver IC 3.

More specifically, when one source driver IC 3 is connected to s switching groups, (s-1) gated pulses need to be input until next source signals are supplied; however, when two source driver ICs 3 are provided for s switching groups, the number of switching groups connected to one source driver IC 3 shall be s/2, and thus, (s/2-1) gated pulses are input until next source signals are supplied.

As described, according to the liquid crystal display according to the present embodiment, similarly to the first preferred embodiment, the number of source driver ICs 3 to be used is reduced. Further, the unnecessity of providing the memory circuit 6 achieves further cost reduction and more improved reliability of the liquid crystal display.

### Fourth Preferred Embodiment

While the first to third preferred embodiments have been directed to reducing the number of source driver ICs 3, a fourth preferred embodiment will be directed to reducing the number of gate driver ICs in a liquid crystal display.

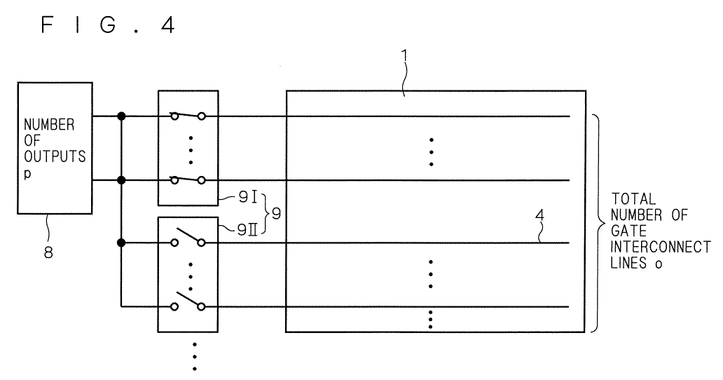

FIG. 4 is a circuit diagram showing a liquid crystal display according to the present embodiment. In FIG. 4, a gate driver IC 8 is connected to gate interconnect lines 4 provided on the liquid crystal panel 1. It should be noted that illustration of active elements and pixels in the liquid crystal panel 1 is omitted in FIG. 4. Source interconnect lines and source driver ICs are also omitted from illustration. Source interconnect lines and source driver ICs may be of conventional configuration or may be configured as described in the first to third preferred embodiments.

In the liquid crystal display according to the present embodiment, the gate interconnect lines 4 and gate driver IC 8 are not directly connected to each other, but a switching circuit 9 is provided therebetween. The switching circuit 9 is configured to be turned on and off for each of the gate interconnect lines 4.

The switching circuit 9 is turned on and off by the number of outputs of the gate driver IC 8. The switching is made in a unit called a switching group. FIG. 4 shows that the switching circuit 9 is packaged by each switching group, however, the present invention is not limited as such, but may be implemented by packaging each several switching groups or packaging the whole switching groups all together.

Providing the switching circuit 9 in the liquid crystal display according to the present embodiment, one gate driver IC 8 can supply gated pulses to the gate interconnect lines 4 connected to a plurality of switching groups. With reference to FIG. 4, by way of example, the gate driver IC 8 is connected to the switching circuit 9 formed by a plurality of switching groups including a switching group 9I and a switching group 9II. With the switching group 9I remaining on and the switching group 9II remaining off as shown, the gate driver IC 8 supplies gated pulses to the gate interconnect lines 4 connected to the switching group 9I.

Next, the number u of switching groups required in the case where one gate driver IC 8 supplies gated pulses to all the gate interconnect lines 4 is calculated. Let the total number of gate interconnect lines be o, and the number of outputs of one gate driver IC 8 be p. Then, the number u of switching groups required is obtained by dividing the total number of gate interconnect lines o by the number of outputs p. More specifically, in a liquid crystal display of XGA, let the total number of gate interconnect lines o be 756 and the number of outputs p from the gate driver IC 8 be 384, the number u of switching groups shall be 3.

The present invention does not always require one gate driver IC 8 to supply gated pulses to all the gate interconnect lines 4, but a plurality of gate driver ICs 8 may be provided. It should be noted that the number v of gate driver ICs 8 needs to be equal to or less than the number u of switching groups. Accordingly, the number of gate driver ICs 8 is less than in a conventional liquid crystal display. When providing a plurality of gate driver ICs 8, u/v switching groups are connected to one gate driver IC 8.

Next, an operation of the liquid crystal display according to the present embodiment is described with reference to FIG. 4. First, although not shown, p pieces of data are input to the gate driver IC 8 (the number of outputs p) from a controller. The gate driver IC 8 generates p gated pulses on the basis of the input data, and sequentially supplies the gated pulses to the switching circuit 9. The gate driver IC 8 does not output gated pulses at one time like the source driver IC 3, but sequentially outputs gated pulses for each of the gate interconnect lines 4.

The switching circuit 9 has u switching groups, each of which is individually turned on and off. As mentioned above, with the switching group 9I remaining on and the switching group 9II remaining off as shown in FIG. 4, outputs of the gate driver IC 8 are sequentially output as gated pulses for the gate interconnect lines 4 connected to the switching group 9I.

Subsequently, next p pieces of data are input to the gate driver IC 8 from the controller. The gate driver IC 8 generates next p gated pulses on the basis of the input data, and supplies the gated pulses to the switching circuit 9. The switching circuit 9, in synchronization with the outputs of the gate driver IC 8, turns on the switching group 9II and turns off the switching group 9I. Accordingly, next p gated pulses are sequentially output as gated pulses for the gate interconnect lines 4 connected to the switching group 911.

By conducting the above operation until reaching the u-th switching group, the gate driver IC 8 can sequentially output gated pulses to all the gate interconnect lines 4. Supplying source signals from source interconnect lines with the timing when gated pulses are supplied to the gate interconnect lines 4, a desired image can be displayed on the liquid crystal display.

As described above, the liquid crystal display according to the present embodiment has the switching circuit 9 having individually-switchable switching groups for supplying gated pulses (signals) from the gate driver IC 8 to all the gate interconnect lines 4. Accordingly, the number of gate driver ICs 8 to be used is reduced. This, in turn, achieves cost reduction and improved reliability of the liquid crystal display.

While the invention has been shown and described in detail, the foregoing description is in all aspects illustrative and not restrictive. It is therefore understood that numerous modifications and variations can be devised without departing from the scope of the invention.

What is claimed is:

1. A display having active elements and pixels arrayed in a matrix and driving said active elements to apply a voltage to said pixels for displaying an image, said display comprising:
a gate driver circuit for generating a signal for controlling said active elements;
a plurality of gate interconnect lines for supplying said signal to said active elements;
a source driver circuit for generating a voltage to be applied to said pixels;
a plurality of source interconnect lines for supplying said voltage to said pixels; and
a first switching circuit provided between said source driver circuit and said plurality of source interconnect lines, said first switching circuit having individually-switchable groups for supplying said voltage generated by said source driver circuit to all of said plurality of source interconnect lines.

2. The display according to claim 1, further comprising
a memory circuit for temporarily storing outputs of said first switching circuit and supplying said outputs to all of said plurality of source interconnect lines almost at the same time.

3. The display according to claim 1, further comprising
a buffer circuit for holding outputs of said first switching circuit for a predetermined period of time.

4. The display according to claim 1, further comprising
a second switching circuit provided between said gate driver circuit and said plurality of gate interconnect lines, said second switching circuit having individually-switchable groups for supplying said signal generated by said gate driver circuit to all of said plurality of gate interconnect lines.

5. The display according to claim 2, further comprising
a second switching circuit provided between said gate driver circuit and said plurality of gate interconnect lines, said second switching circuit having individually-switchable groups for supplying said signal generated by said gate driver circuit to all of said plurality of gate interconnect lines.

6. The display according to claim 3, further comprising
a second switching circuit provided between said gate driver circuit and said plurality of gate interconnect lines, said second switching circuit having individually-switchable groups for supplying said signal generated by said gate driver circuit to all of said plurality of gate interconnect lines.

7. A display having active elements and pixels arrayed in a matrix and driving said active elements to apply a voltage to said pixels for displaying an image, said display comprising:
a gate driver circuit for generating a signal for controlling said active elements;
a plurality of gate interconnect lines for supplying said signal to said active elements;
a source driver circuit for generating a voltage to be applied to said pixels;
a plurality of source interconnect lines for supplying said voltage to said pixels; and
a switching circuit provided between said source driver circuit and said plurality of gate interconnect lines, said switching circuit having individually-switchable groups for supplying said signal generated by said gate driver circuit to all of said plurality of gate interconnect lines.
